(19) United States
(12) Patent Application Publication
(10) Pub. No.: US 2026/0122546 A1
(43) Pub. Date: Apr. 30, 2026

(54) USER DEVICE AWARENESS BASED VOICE CALL HANDOVER

(71) Applicant: T-MOBILE INNOVATIONS LLC, Overland Park, KS (US)

(72) Inventor: Lin ZHANG, Overland Park, KS (US)

(21) Appl. No.: 18/926,775

(22) Filed: Oct. 25, 2024

(51) Int. Cl. H04W 36/14; H04W 36/08; H04W 84/12

(52) U.S. Cl. CPC H04W 36/144; H04W 36/08; H04W 84/12

(57) ABSTRACT

Systems and methods for user device handover management are provided. An indication of whether a base station supports Voice over New Radio (VoNR) on a first cell is received. A user device is connected to the first cell and the first cell is a 5G NR cell. While on a Voice over Wi-Fi (VoWiFi) call, it is determined whether the base station supports VoNR on the first cell based on the indication. In response to determining that the base station does not support VoNR on the first cell, a connection is switched for the user device from the first cell to a second cell that is different from the first cell.

### SUMMARY

The present disclosure is directed, in part, to user device awareness based voice call handovers substantially as shown in and/or described in connection with at least one of the figures, and as set forth more completely in the claims.

A high-level overview of various aspects of the present technology is provided in this section to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In aspects set forth herein, and at a high level, the technology described herein relates to facilitating a voice call handover from Voice over Wi-Fi (VoWiFi) to cellular based, at least in part, on user device awareness of support for Voice over New Radio (VoNR) for different cells of one or more base stations. While user devices are typically unaware of whether a base station supports VoNR on particular cells, aspects herein provide for providing an indication of whether a base station supports VoNR on particular cells and proactively switching a connection for a user device to a 5G NR cell that supports VoNR or an LTE cell prior to requesting a handover from VoWiFi to cellular. The techniques described herein enhance user device awareness and may significantly reduce the number of dropped calls experienced when requesting a handover from VoWiFi to cellular.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example computing device, in accordance with aspects herein;

FIG. 2 is a diagram illustrating an example network environment for use in accordance with aspects herein;

FIG. 3 is flow chart illustrating an example method for user device handover management, in accordance with aspects herein;

FIG. 4 is flow chart illustrating an example method for switching a connection with the user device from a first cell to a second cell in preparation for a handover from Voice over Wi-Fi (VoWiFi) to cellular, in accordance with aspects herein; and

FIG. 5 is flow chart illustrating another example method for switching a connection with the user device from a first cell to a second cell in preparation for a handover from VoWiFi to cellular, in accordance with aspects herein.

### DETAILED DESCRIPTION

The subject matter of embodiments of the present disclosure is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

By way of background, a voice call for a user device may be implemented over Wi-Fi (e.g., using Voice over Wi-Fi (VoWiFi)) or cellular (e.g., using Voice over New Radio (VoNR) or Voice over LTE (VoLTE)). Mobile network operators (MNOs) are in the process of deploying 5G service across their networks, but there are still coverage areas where 5G service may not be available or where some 5G services (e.g., VoNR) may not be supported on at least some cells of a base station (e.g., 5G gNodeB (gNB)). When a voice call is initiated on cellular for a user device that supports VoNR and the user device is connected to a 5G NR cell, the base station will initiate the call using VoNR if the base station supports it. However, if the base station does not support VoNR on the 5G NR cell, the base station will initiate an Evolved Packet System Fallback (EPS-FB) and the voice call will be implemented using VoLTE. Situations may arise where a user device requests a handover of a voice call from VoWiFi to VoNR (e.g., when the user device moves from indoors to outdoors), but the base station may or may not support VoNR on the serving cell for the user device. If the base station does not support VoNR on the serving cell for the user device, MNOs may implement different call flows for handling this situation because 3GPP doesn’t have a mandatory and precise enough call flow defined. The user device may not use, or be aware of, the proper call flow implemented by the MNO, which can lead to poor user experience.

Conventionally, when a user device is on a VoWiFi call and the user device supports VoNR, the user device sends a request for a handover from VoWiFi to VoNR when it is connected to a 5G NR cell. If the base station or the serving cell does not support VoNR, the base station may initiate an EPS-FB procedure by sending an RRC release with redirection to LTE (may include list of LTE bands) to the user device. Many user devices are not able to handle this situation and drop the call for various reasons. If the EPS-FB procedure is successfully completed, many user devices will not repeat the handover decision process or submit the handover request again over LTE, which eventually results in a dropped call. Some user devices may send a request for handover from VoWiFi to VoLTE after a successful EPS-FB procedure, but many of these user devices include an “initial request” indicator in a PDN Connectivity Request, which results in an IP address change and a dropped call. Accordingly, many user devices experience a high level of dropped calls after requesting a handover from VoWiFi to VoNR.

Some user devices may be capable of successfully completing the EPS-FB procedure and executing a handover from VoWiFi to VoLTE after initially requesting a handover from VoWiFi to VoNR. However, even if these user devices successfully complete this handover procedure, the user devices may experience larger audio interruptions compared to direct handovers from VoWiFi to VoNR/VoLTE due to the additional time required to perform the EPS-FB procedure.

Unlike conventional solutions, the present disclosure is directed to increasing the awareness of VoNR capabilities of the base station for user devices that may need to handover a voice call from VoWiFi to cellular. The user device receives an indication of whether the base station supports VoNR on a particular cell, and, while on a VoWiFi call, the user device determines whether the base station supports VoNR on the particular cell to which it is connected based on the indication. If the base station does support VoNR on the particular cell, then the user device may request a VoWiFi to VoNR handover without changing the cell it is connected to. However, if the base station does not support VoNR on the particular cell, then the user device switches from the first cell to a second cell. In some embodiments, the second cell may be a different 5G NR cell that supports VoNR or the second cell may be an LTE cell and the user device proactively falls back to LTE without requesting a VoWiFi to VoNR handover. By increasing the user device’s awareness of the base station VoNR capabilities for particular cells, the user device proactively switches the connection to a different cell and avoids the problematic call flow described above that leads to dropped calls for a majority of user devices. Accordingly, the time required to execute the VoWiFi to cellular handover procedure and the complexity of the VoWiFi to cellular handover procedure is significantly reduced compared to current techniques, which leads to better service quality and reduced instances of dropped calls for user devices that utilize the techniques described herein.

In one aspect, a method is provided for user device handover management. The method includes receiving an indication of whether a base station supports VoNR on a first cell. The user device is connected to the first cell and the first cell is a 5G NR cell. The method also includes, while on a VoWiFi call, determining whether the base station supports VoNR on the first cell based on the indication. Further, the method includes, in response to determining that the base station does not support VoNR on the first cell, switching a connection for the user device from the first cell to a second cell that is different from the first cell.

In another aspect, a user device is provided. The user device includes one or more processors and one or more computer-readable media storing computer-usable instructions that, when executed by the one or more processors, cause the one or more processors to perform a method. The method includes receiving, from a base station, an indication of whether the base station supports VoNR on a first cell. The user device is connected to the first cell and the first cell is a 5G NR cell. The method also includes, while on a VoWiFi call, determining whether the base station supports VoNR on the first cell based on the indication. Further, the method includes, in response to determining that the base station does not support VoNR, switch a connection for the user device from the first cell to a second cell that is different from the first cell.

In yet another aspect, a system is provided. The system includes a base station configured to provide an indication of whether the base station supports VoNR on a first cell. The system further includes a user device connected to the first cell of the base station. The user device is configured to receive the indication of whether the base station supports VoNR on the first cell. While on a VoWiFi call, the user device is configured to determine whether the base station supports VoNR on the first cell based on the indication. The user device is further configured to, in response to determining that the base station does not support VoNR on the first cell, switch a connection for the user device from the first cell to a second cell that is different from the first cell.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunications arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

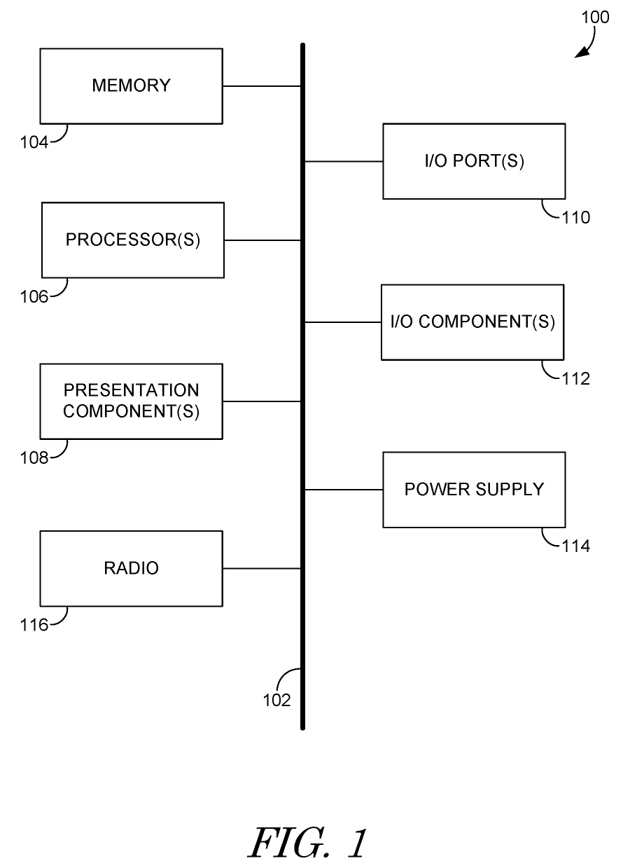

Referring to the drawings in general, and initially to FIG. 1, an exemplary computing device 100 suitable for practicing embodiments of the present technology is provided. The computing device 100 is just one example, and is not intended to suggest any limitation as to the scope of use or functionality of the embodiments discussed herein. Furthermore, the computing device 100 should not be interpreted as having any dependency or requirement relating to any one or a combination of components illustrated. It should be noted that although some components in FIG. 1 are shown in the singular, they may be plural. For example, the computing device 100 might include multiple processors and/or multiple radios. As shown in FIG. 1, computing device 100 includes a bus 102 that directly or indirectly couples various components together, including a memory 104, processor(s) 106, presentation component(s) 108 (if applicable), radio(s) 116, input/output (I/O) port(s) 110, I/O component(s) 112, and a power supply 114. More or fewer components are possible and contemplated, including in consolidated or distributed form.

The memory 104 may take the form of memory components described herein. Thus, further elaboration will not be provided here, but it should be noted that the memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. The processor 106 may actually be multiple processors that receive instructions and process them accordingly. The presentation component 108 may include a display, a speaker, and/or other components that may present information (e.g., a display, a screen, a lamp (LED), a graphical user interface (GUI), and/or even lighted keyboards) through visual, auditory, and/or other tactile cues.

The radio 116 may facilitate communication with a network, and may additionally or alternatively facilitate other types of wireless communications, such as Wi-Fi, WiMAX, LTE, 5G, 6G, and/or other VoIP communications. In various embodiments, the radio 116 may be configured to support multiple technologies, and/or multiple radios may be configured and utilized to support multiple technologies. The I/O ports 110 may take a variety of forms. Exemplary I/O ports may include a USB jack, a stereo jack, an infrared port, a firewire port, other proprietary communications ports, and the like. The I/O components 112 may comprise keyboards, microphones, speakers, touchscreens, and/or any other item usable to directly or indirectly input data into the computing device 100. Power supply 114 may include batteries, fuel cells, and/or any other component that may act as a power source to supply power to the computing device 100 or to other network components, including through one or more electrical connections or couplings. Power supply 114 may be configured to selectively supply power to different components independently and/or concurrently.

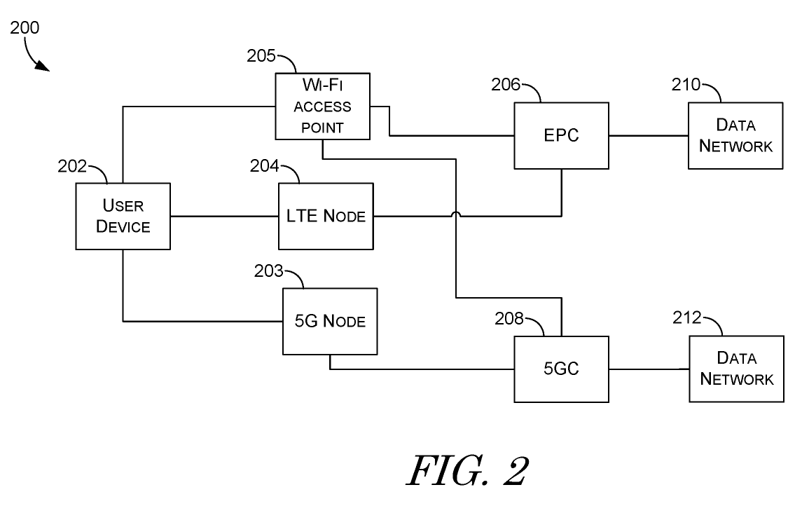

Turning to FIG. 2, FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the embodiments discussed herein. Neither should the network environment be interpreted as having any dependency or requirement relating to any one or combination of components illustrated.

As shown in FIG. 2, the network environment 200 comprises a user device 202, a 5G node 203, an LTE node 204, a Wi-Fi access point 205, an Evolved Packet Core (EPC) 206, a 5G Core (5GC) 208, a first data network 210, and a second data network 212. It should be noted that although some components in FIG. 2 are shown in the singular, they may be plural. For example, the network environment 200 may include multiple 5G nodes 203, multiple LTE nodes 204, and/or multiple Wi-Fi access points 205. More or fewer components are possible and contemplated, including in consolidated or distributed form.

The user device 202 may include any device employed by an end-user to communicate with a telecommunications network, such as a wireless telecommunications network. The user device 202 may, in general, comprise forms of equipment and machines such as but, not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, the user device 202 may include computing devices such as, but not limited to, handheld personal computing devices, cellular phones, smartphones, tablets, laptops, and similar consumer equipment, or stationary desktop computing devices, workstations, servers and/or network infrastructure equipment. As such, the user device 202 may be a mobile UE or a stationary UE. The user device 202 may include one or more processors, and one or more non-transient computer-readable media for executing code to carry out the functions of the user device 202 described herein. The computer-readable media may include computer-readable instructions executable by the one or more processors. In some embodiments, the user device 202 may be implemented using a computing device 100 as discussed below with respect to FIG. 1.

Nodes, such as the 5G node 203 and LTE node 204, are often individually referred to as a radio access network (RAN) and/or a wireless communication base station system. The 5G node 203 and the LTE node 204 may support or contain one or more cells and each cell utilizes a different frequency band.

In the embodiment shown in FIG. 2, the 5G node 203 may function as an access node via which the user device 202 within coverage area of the 5G node 203 can wirelessly access services of the 5GC 208, such as telecommunications and data connectivity. In the context of 5G NR, the 5G node 203 may be referred to as a 5G base station, a gNodeB, or gNB. In the embodiment shown in FIG. 2, the LTE node 204 may function as an access node via which the user device 202 within coverage area of the LTE node 204 can wirelessly access services of the EPC 206, such as telecommunications and data connectivity. In the context of 4G LTE, the LTE node 204 may be referred to as an LTE base station, an eNodeB, or eNB.

The 5G node 203 and LTE node 204 may be terrestrial or extraterrestrial. Other terminology may also be used depending on the specific implementation technology. As such, in some embodiments, the network environment 200 comprises, at least in part, a wireless communications network, such as the EPC 206 and the 5GC 208. The EPC 206 and the 5GC 208 also communicate with the first data network 210 and the second data network 212, respectively.

In some embodiments, the 5G node 203 and/or LTE node 204 may comprise a multi-modal network (e.g., comprising one or more multi-modal access devices) where multiple radios supporting different systems are integrated into the radio of the 5G node 203 and/or the LTE node 204. Such a multi-modal RAN may support a combination of 3GPP radio technologies (e.g., 4G, 5G and/or 6G) and/or non-3GPP radio technologies.

The EPC 206 may be a component of a wireless communications network that provides one or more wireless network services to one or more devices (e.g., user device 202) within the coverage areas of a plurality of nodes, including the LTE node 204. In particular, the EPC 206 provides combinations of network services to the user device 202 for one or more LTE cells that the user device 202 may attach to via channels of one or more RF bands (referred to herein as RF band layers).

The 5GC 208 may be a component of a wireless communications network that provides one or more wireless network services to one or more devices (e.g., user device 202) within the coverage areas of a plurality of nodes, including the 5G node 203. In particular, the 5GC 208 provides combinations of network services to the user device 202 for one or more 5G NR cells that the user device 202 may attach to via RF band layers.

The Wi-Fi access point 205 may function as an access node via which the user device 202 within the coverage area of the Wi-Fi access point 205 can wirelessly access a local area networks (LANs) and/or wide area networks (WANs), including the Internet. In the context of the present disclosure, the Wi-Fi access point 205 provides a wireless connection for VoWiFi service provided to the user device 202.

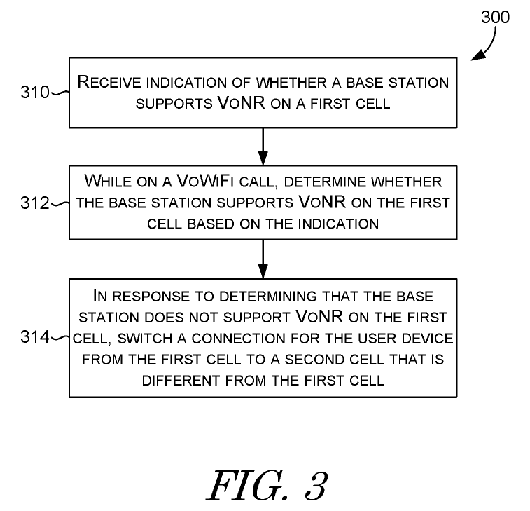

Turning now to FIG. 3, a method 300 is provided for user device handover management, in accordance with some embodiments of the present disclosure. It should be understood that the features and elements described herein with respect to the method 300 of FIG. 3 may be used in conjunction with, in combination with, or substituted for elements of, any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa. The method 300 may be performed by a user device (e.g., computing device 100 or user device 202 described above with respect to FIGS. 1-2).

At block 310, an indication of whether a base station supports VoNR on a first cell is received. In the examples described herein, the first cell is a 5G NR cell. The indication of whether the base station supports VoNR on the first cell may be received by a user device (e.g., user device 202) in a number of different ways.

In some embodiments, the indication of whether the base station supports VoNR on the first cell may be an Information Element (IE) contained in a System Information Block (SIB) transmitted by the base station. The IE may indicate the VoNR capabilities of the base station as a whole or on a cell-by-cell basis (e.g., whether the base station supports VoNR on particular cells of the base station, if applicable). The IE may be contained in a SIB2 transmission by the base station, which contains information for the serving cell for the user device. In a non-limiting example, the IE (e.g., vonrCapability) may be added in the “cellReselectionServingFreqInfo” portion of the SIB2 transmission and may be implemented, for example, using Boolean logic (e.g., using a 1 or 0 to indicate whether VoNR is supported on the serving cell or not).

In some embodiments, the indication of whether the base station supports VoNR on the first cell may be provided when the user device initiates a voice call on cellular on the first cell. For example, it may be inferred that the base station supports VoNR on the first cell if the voice call is initiated using VoNR, and it may be inferred that the base station does not support VoNR on the first cell if the base station performs an EPS-FB. In response to either action by the base station, the user device may store the inferred VoNR capability of the base station on the first cell (e.g., in a computer-storage media of the user device).

The indication of whether the base station supports VoNR on the first cell may also be provided when the user device attempts a handover from VoWiFi to VoNR when the user device is attached to the first cell (e.g., prior to the user device receiving any indication of the VoNR capabilities of the base station on the first cell). For example, it may be inferred that the base station supports VoNR on the first cell if the base station executes a VoWiFi to VoNR handover, and it may be inferred that the base station does not support VoNR on the first cell if the base station sends an RRC release and redirection to LTE in response to the requested handover from VoWiFi to VoNR.

For the examples where the indication of whether the base station supports VoNR on the first cell may be inferred based on various actions by the base station, the user device may store the inferred VoNR capability of the base station on the first cell in a table or other data structure on a computer-storage media of the user device. In some embodiments, the user device may store indications of whether the base station supports or does not support VoNR on particular cells. The user device may also store only indications that the base station does not support VoNR on the first cell (e.g., to save memory resources of the user device). The user device may be configured to store the indication for a certain number of base stations or cells of a base station and limit the storage to base stations or cells to which the user device has recently connected.

The information stored may indicate whether the base station supports VoNR on specific cells (e.g., associating the VoNR capability with a cell identifier (e.g., local cell ID)), whether the base station as a whole supports VoNR (e.g., associating the VoNR capability with a base station identifier (e.g., gNB ID)), or a combination (e.g., associating the VoNR capability with an identifier that includes both the cell identifier and base station identifier (e.g., a NCI)).

At block 312, while the user device is on a VoWiFi call, it is determined whether the base station supports VoNR on the first cell based on the indication. The user device may query the SIB from the base station for the IE that indicates VoNR capability and determine whether the base station supports VoNR on the first cell based on whether the IE in the SIB from the base station indicates that the base station supports VoNR on the first cell. In the non-limiting example, the user device may query the SIB2 transmission for the IE in the “cellReselectionServingFreqInfo” portion of the SIB2.

The user device may also query the table or other data structure in the computer-storage media of the user device that includes information inferred about the VoNR capabilities of the base station on the first cell. The user device may determine whether the base station supports VoNR on the first cell based on whether an indicator in the table or other data structure indicates whether the base station as a whole supports VoNR or whether the base station supports VoNR on the first cell. In some embodiments, if no indication is stored in the table or other data structure, the user device may make a default determination that the base station supports VoNR on the first cell.

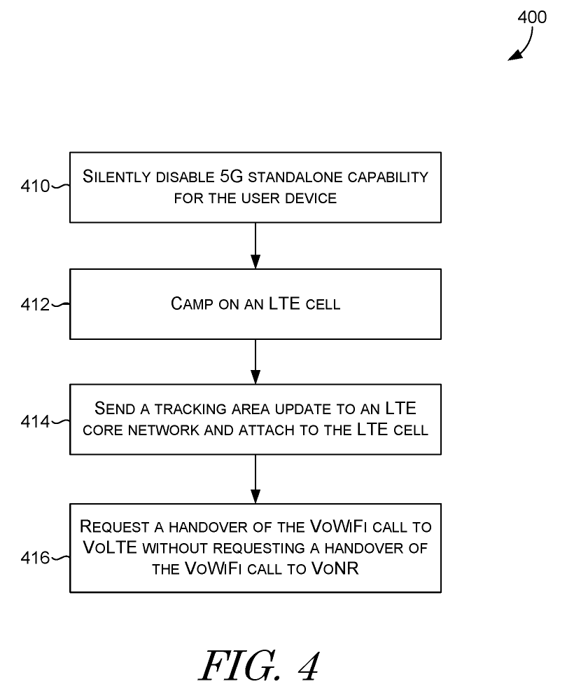

At block 314, in response to determining that the base station does not support VoNR on the first cell, a connection for the user device is switched from the first cell to a second cell that is different from the first cell. In some embodiments, the second cell may be an LTE cell. The connection switch to an LTE cell involves a proactive fallback to LTE prior to making a handover request from VoWiFi to cellular. In order to perform the proactive fallback to LTE, the user device must be in an RRC IDLE mode and follows a procedure discussed further with respect to FIG. 4.

In some embodiments, the second cell may be a 5G NR cell. Further, the second cell may be a 5G NR cell of the current base station that the user device is connected to or the second cell may be a 5G NR cell of a different base station. The connection switch to a different 5G NR cell involves proactively switching to the second cell prior to making a handover request from VoWiFi to cellular. In order to perform proactively switching to the different 5G NR cell, the user device must be in an RRC IDLE mode. In some embodiments, the user device searches a list of neighbor 5G NR cells that includes the second cell and determines whether the second cell supports VoNR. If multiple neighbor cells in the list support VoNR, then the user device may utilize other factors in determining which of the neighbor cells to select. For example, the user device may consider a predefined priority of the 5G NR cells sent from the base station, the signal strength of the neighbor 5G NR cells, and the like. In some embodiments, the user device may select the highest priority cell identified by the base station that also supports VoNR and has acceptable signal strength for the connection.

Referring now to FIG. 4, a method 400 is provided for switching a connection with the user device from a first cell to a second cell in preparation for a handover from VoWiFi to cellular, in accordance with some embodiments of the present disclosure. It should be understood that the features and elements described herein with respect to the method 400 of FIG. 4 may be used in conjunction with, in combination with, or substituted for elements of, any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa. The method 400 may be performed by a user device (e.g., computing device 100 or user device 202 described above with respect to FIGS. 1-2).

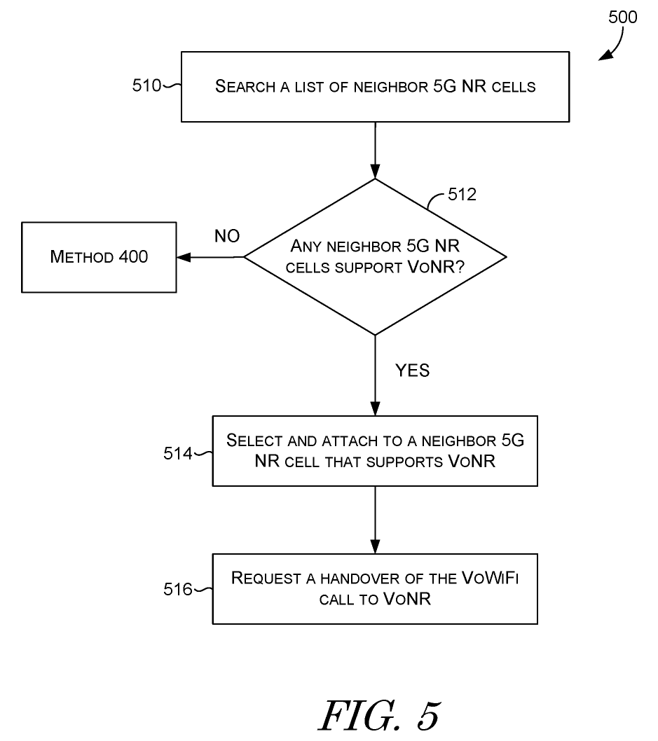

At block 410, 5G standalone capability is silently disabled for the user device. In some embodiments, the user device may be configured to silently disable its 5G standalone capability in response to a determination that the base station does not support VoNR on the first cell. The user device may also be configured to silently disable its 5G standalone capability in response to a determination that no neighboring 5G NR cells support VoNR (e.g., as described with respect to block 512 of FIG. 5).

At block 412, the user device camps on an LTE cell (e.g., the second cell). The user device may search for available LTE cells, select an LTE cell with the highest priority (e.g., based on a predefined priority from the base station) that has an acceptable signal strength, and utilize other existing techniques to camp on the LTE cell as defined by 3GPP.

At block 414, the user device sends a tracking area update (TAU) to an LTE core network and attaches to the LTE cell. Once the user device determines that the switch to the LTE cell is needed, the user device sends a TAU request and attaches to the LTE cell using existing techniques defined by 3GPP.

At block 416, the user device requests a handover of the VoWiFi call to VoLTE without requesting a handover of the VoWiFi call to VoNR. The call flow used for the handover of the VoWiFi call to VoLTE follows the standardized procedure as provided by 3GPP with the user device being attached to the LTE cell.

Referring now to FIG. 5, another method 500 is provided for switching a connection with the user device from a first cell to a second cell in preparation for a handover from VoWiFi to cellular, in accordance with some embodiments of the present disclosure. It should be understood that the features and elements described herein with respect to the method 500 of FIG. 5 may be used in conjunction with, in combination with, or substituted for elements of, any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa. The method 500 may be performed by a user device (e.g., computing device 100 or user device 202 described above with respect to FIGS. 1-2).

At block 510, a list of neighbor 5G NR cells is searched. In some embodiments, the user device may be configured to search the list of neighbor 5G NR cells in response to a determination that the base station does not support VoNR on the first cell. The neighbor 5G NR cells may be cells of the current base station that the user device is connected to or the neighbor 5G NR cells may be cells of a different base station.

At block 512, it is determined whether any of the neighbor 5G NR cells support VoNR. In some embodiments, the user device may query the table or other data structure in the computer-storage media of the user device that includes information about whether VoNR is supported on the neighbor 5G NR cells. The user device determines whether the neighbor 5G NR cells support VoNR based on whether an indicator in the table or other data structure indicates that the neighbor 5G NR cells support VoNR. In some embodiments, if no indication is stored in the table or other data structure for a particular neighbor 5G NR cell, the user device may make a default determination that the particular neighbor 5G NR cell supports VoNR.

The user device may also query a SIB from the base station for an IE that indicates VoNR capability for neighboring 5G NR cells. The IE may be contained in a SIB3 transmission by the base station, which contains information for neighbor cells having the same frequency band as the serving cell. In a non-limiting example, the IE (e.g., vonrCapability) may be added in the “IntraFreqNeighCellInfo” portion of the SIB3 transmission and may be implemented, for example, using Boolean logic (e.g., using a 1 or 0 to indicate whether VoNR is supported on the neighbor 5G NR cell or not). The IE may also be contained in a SIB4 transmission by the base station, which contains information for neighbor cells having a different frequency band than the serving cell. In a non-limiting example, the IE (e.g., vonrCapability) may be added in the “InterFreqNeighCellInfo” portion of the SIB4 transmission and may be implemented, for example, using Boolean logic (e.g., using a 1 or 0 to indicate whether VoNR is supported on the neighbor 5G NR cell or not).

If it is determined that none of the neighbor 5G NR cells support VoNR, then the method 400 discussed above with respect to FIG. 4 may be performed by the user device in response to this determination. However, if it is determined that one or more of the neighbor 5G NR cells support VoNR, the method 500 proceeds to block 514.

At block 514, the user device selects and attaches to a neighbor 5G NR cell that supports VoNR. Typically, VoNR capability is not a factor for user devices when selecting a neighbor 5G NR cell to switch to. In some embodiments, the user device may select a neighbor 5G NR cell with the highest priority (e.g., based on a predefined priority from the base station) that has an acceptable signal strength and supports VoNR. The user device may camp on the selected neighbor 5G NR cell until it determines that a handover from VoWiFi to VoNR is needed. The user device otherwise utilizes existing techniques to attach to the neighbor 5G NR cell as defined by 3GPP.

At block 516, the user device requests a handover of the VoWiFi call to VoNR. The call flow used for the handover of the VoWiFi call to VoNR follows the standardized procedure as provided by 3GPP with the user device being attached to the neighbor 5G NR cell that supports VoNR.

As used herein, the terms “function”, “unit”, “server”, “node” and “module” are used to describe computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method of user device handover management, comprising:
receiving an indication of whether a base station supports Voice over New Radio (VoNR) on a first cell, wherein a user device is connected to the first cell and the first cell is a 5G NR cell;
while on a Voice over Wi-Fi (VoWiFi) call,
determining whether the base station supports VoNR on the first cell based on the indication; and
in response to determining that the base station does not support VoNR on the first cell, switching a connection for the user device from the first cell to a second cell that is different from the first cell.

2. The method of claim 1, wherein receiving the indication of whether the base station supports VoNR on the first cell includes receiving an Information Element (IE) contained in a System Information Block (SIB) transmitted by the base station.

3. The method of claim 1, wherein receiving the indication of whether the base station supports VoNR on the first cell includes receiving an Evolved Packet System-Fallback (EPS-FB) instruction in a process for a voice call initiation on the first cell or in response to a previous request for a handover from VoWiFi to VoNR on the first cell.

4. The method of claim 1, wherein the second cell is a Long Term Evolution (LTE) cell, wherein switching to the second cell includes:
silently disabling 5G standalone capability for the user device;
camping on the second cell; and
sending a Tracking Area Update to an LTE core network and attach to the second cell.

5. The method of claim 4, further comprising requesting a handover of the VoWiFi call to Voice over LTE (VoLTE) without requesting a handover of the VoWiFi call to VoNR.

6. The method of claim 1, wherein the second cell is 5G NR cell, wherein switching to the second cell includes:
searching a list of neighbor cells that includes the second cell;
determining whether the second cell supports VoNR; and
in response to determining that the second cell supports VoNR, attaching to the second cell.

7. The method of claim 6, further comprising requesting a handover of the VoWiFi call to VoNR.

8. The method of claim 1, wherein the second cell is a Long Term Evolution (LTE) cell, wherein switching to the second cell includes:
searching a list of neighbor 5G NR cells;
determining whether any neighbor 5G NR cells from the list of neighbor 5G NR cells support VoNR;
in response to determining that none of the neighbor 5G NR cells from the list of neighbor 5G NR cells support VoNR,
silently disabling 5G standalone capability;
camp on the second cell; and
send a Tracking Area Update to an LTE core network and attach to the second cell.

9. The method of claim 8, further comprising requesting a handover of the VoWiFi call to Voice over LTE (VoLTE) without requesting a handover of the VoWiFi call to VoNR.

10. A user device, comprising:
one or more processors; and
one or more computer-readable media storing computer-usable instructions that, when executed by the one or more processors, cause the one or more processors to:
receive, from a base station, an indication of whether the base station supports Voice over New Radio (VoNR) on a first cell, wherein the user device is connected to the first cell and the first cell is a 5G NR cell;
while on a Voice over Wi-Fi (VoWiFi) call,
determine whether the base station supports VoNR on the first cell based on the indication; and
in response to determining that the base station does not support VoNR, switch a connection for the user device from the first cell to a second cell that is different from the first cell.

11. The user device of claim 10, wherein the one or more processors are configured to receive the indication of whether the base station supports VoNR on the first cell in a System Information Block (SIB) transmitted by the base station.

12. The user device of claim 10, wherein the computer-usable instructions further cause the one or more processors to store the indication of whether the base station supports VoNR on the first cell in response to an Evolved Packet System-Fallback (EPS-FB) instruction received from the base station (1) as part of a voice call initiation on the first cell or (2) in response to a previous request for handover from VoWiFi to VoNR on the first cell.

13. The user device of claim 10, wherein the second cell is an LTE cell, wherein the one or more processors switch the connection for the user device from the first cell to the second cell by:
silently disabling 5G standalone capability for the user device;
camping on the second cell; and
sending a Tracking Area Update to an LTE core network and attach to the second cell.

14. The user device of claim 10, wherein the computer-usable instructions further cause the one or more processors to request a handover of the VoWiFi call to Voice over LTE (VoLTE) without requesting a handover of the VoWiFi call to VoNR.

15. The user device of claim 10, wherein the second cell is 5G NR cell, wherein the one or more processors switch the connection for the user device from the first cell to the second cell by:
searching a list of neighbor cells that includes the second cell;
determining whether the second cell supports VoNR; and
in response to determining that the second cell supports VoNR, attaching to the second cell.

16. The user device of claim 15, wherein the computer-usable instructions further cause the one or more processors to request a handover of the VoWiFi call to VoNR.

17. The user device of claim 10, wherein the second cell is an LTE cell, wherein the one or more processors switch the connection for the user device from the first cell to the second cell by:
searching a list of neighbor 5G NR cells;
determining whether any neighbor 5G NR cells from the list of neighbor 5G NR cells support VoNR;
in response to determining that none of the neighbor 5G NR cells from the list of neighbor 5G NR cells support VoNR,
silently disabling 5G standalone capability;
camping on the second cell; and
sending a Tracking Area Update to an LTE core network and attach to the second cell.

18. A system, comprising:
a base station configured to provide an indication of whether the base station supports Voice over New Radio (VoNR) on a first cell;
a user device connected to the first cell of the base station, wherein the user device is configured to:
receive the indication of whether the base station supports VoNR on the first cell;
while on a Voice over Wi-Fi (VoWiFi) call,
determine whether the base station supports VoNR on the first cell based on the indication; and
in response to determining that the base station does not support VoNR on the first cell, switch a connection for the user device from the first cell to a second cell that is different from the first cell.

19. The system of claim 18, wherein the indication of whether the base station supports VoNR on the first cell is included in a System Information Block (SIB) transmitted by the base station.

20. The system of claim 18, wherein the user device is configured to store the indication of whether the base station supports VoNR on the first cell in response to an Evolved Packet System-Fallback (EPS-FB) instruction received from the base station (1) as part of a voice call initiation on the first cell or (2) in response to a previous request for handover from VoWiFi to VoNR on the first cell.
